(19) United States
(12) Patent Application Publication
(10) Pub. No.: US 2008/0123062 A1
(43) Pub. Date: May 29, 2008

(54) PROJECTOR

(75) Inventor: Eiji Morikuni, Matsumoto-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 11/942,419

(22) Filed: Nov. 19, 2007

(30) Foreign Application Priority Data
Nov. 28, 2006 (JP) 2006-319740
Sep. 25, 2007 (JP) 2007-246672

(51) Int. Cl. G03B 21/28; G03B 21/14

(52) U.S. Cl. 353/99; 353/119; 353/98

(57) ABSTRACT

A projector includes a projection engine section including a light source section, an image forming section for displaying an image of a desired size on an irradiated surface using light from the light source section, and projecting light corresponding to an image signal to the irradiated surface, and a housing for housing the projection engine section, wherein the projection engine section is capable of moving in the housing in a direction along a light path.

### BACKGROUND

1. Technical Field

The present invention relates to a technical field of a projector, and in particular to a technical field of a projector capable of close-up protection for projecting light from a position near the irradiated surface.

2. Related Art

Most of the projectors which have been in widespread use in the past are placed at positions rather distant from screens in order for assuming an appropriate projection distance. In the case in which the projector is placed at a position distant from the screen, it is required to provide a space where no obstacles for blocking the light exist in the light path between the projector and the screen. The larger the display screen becomes, the more remarkable such a restriction in the installation position of the projector becomes. In particular, in the case of a small room, projection of a large screen becomes difficult. Further consideration to preventing intervenient into the light path should also be given while displaying images.

In recent years, a technology for performing close-up projection with a front projection projector has been proposed. By enabling the close-up projection, it becomes possible to place the protector at a position near, for example, a wall surface. By making it possible to place the projector at a position near the wall surface, for example, a position within several tens of centimeters from the wall surface, the restriction in the installation position of the projector can be eased, thus enabling space reduction. Further, display with a large screen becomes possible even in a small room, and in addition, the consideration to preventing intervenient into the light path can also be reduced. In the projectors for performing close-up projection, there are adopted ultra short focus optical systems. By using the ultra short focus optical system, it becomes possible to display a large screen with a short projection distance. In order for realizing the ultra short focus, an optical element capable of making the light dramatically wide-angle is required. A large amount of cost should be required for making the light wide-angle by only light transmissive optical elements such as lenses. In contrast, in a technology proposed in, for example, JP-A-2002-40326 (Document 1), the ultra short focus is achieved by a combination of only aspherical mirrors.

Most of the projectors which have been in widespread use in the past are provided with a zoom function for adjusting the screen size. In general, the zoom function of a projector is realized by position adjustment and so on of optical elements forming the optical system. In the case of the ultra short focus optical system having such a configuration as proposed in the Document 1, very high difficulty level of design is required only for achieving the dramatically wide-angle light. Therefore, such design as to add the zoom function to the configuration of making the dramatically wide-angle light possible becomes extremely difficult. Even if the design for incorporating the zoom function is possible, it results in a complicated configuration and steep increase in the cost thereof. In view of such circumstances, most of the projectors implementing the ultra short focus optical systems such as the configuration proposed in the Document 1 should assure the zoom function by a method of moving the body of the projectors. The configuration requiring the body of the projector to be displaced every time the screen size is adjusted is inconvenient, and moreover, places a restriction in permanent installation of the projector. As described above, in the related art, there is a problem that it is difficult to realize the configuration capable of both the close-up projection and the easy adjustment of the screen size.

### SUMMARY

An advantage of some aspects of the present invention is to provide a projector capable of easily adjusting the screen size in performing the close-up projection.

According to an aspect of the invention, it is possible to provide a projector including a projection engine section including a light source section and an image forming section for projecting an image on an irradiated surface using light from the light source section, and a housing for housing the projection engine section, wherein the projection engine section is capable of moving in the housing in a direction along a light path.

By moving the projection engine section to vary the projection distance, the adjustment of the screen size can be performed. By moving the projection engine section inside the housing, relocation of the projector which has once been installed can be eliminated. Therefore, both of the permanent fixing of the projector and the zoom function can be realized. In particular, in the case of using the ultra short focus optical system, the screen size can dramatically be changed even by such a movement of the projection engine section as allowed with the normal sized housing. Regarding the optical system of the projection engine section, by eliminating the need for incorporating the zoom function into the design of the optical system, the zoom function can easily be realized without increasing difficulty in designing the optical system and complexity of the configuration of the optical system. Since it is only required to make the projection engine section movable, a configuration which can easily be designed can be adopted, thus reduction in the manufacturing cost becomes possible. Further, a highly reliable zoom mechanism with a high accuracy can be realized with a simple configuration. Thus, the projector capable of easily adjusting the screen size in the case of performing close-up projection can be obtained.

Further, in a preferable aspect of the invention, the image forming section preferably includes an angle widening reflection section for making light wide-angle by reflection. Thus, the dramatic angle widening of the light becomes possible to obtain the configuration capable of performing the close-up projection.

Further, in another preferable aspect of the invention, the image forming section includes a projection lens, and the angle widening reflection section preferably makes the light from the projection lens wide-angle. The projection lens performs image forming on the irradiated surface and angle widening of the light. The angle widening reflection section makes the light from the projection lens dramatically wide-angle. Thus, the configuration capable of performing the close-up projection can be obtained.

Further, in another preferable aspect of the invention, the projection lens and the angle widening reflection section are preferably disposed so as to have substantially identical optical axes, and preferably shift the light to a specific side from the optical axes. By shifting the light to the specific side from the optical axes, the proceeding direction of the light can be aligned so as to have a large incident angle to the irradiated surface. Thus, the close-up projection can be performed.

Further, in another preferable aspect of the invention, the projection engine section is preferably configured so as to allow a focus adjustment. Since the projection distance is varied in the process of adjusting the screen size, the focus adjustment becomes necessary. Thus, a high quality image can be displayed every time the screen size is adjusted.

Further, in another preferable aspect of the invention, the image forming section preferably includes a projection lens having a plurality of optical elements, and an angle widening reflection section for making the light from the projection lens wide-angle, and at least one of the optical elements forming the projection lens is preferably movable in an optical axis direction. Thus, the configuration capable of performing the focus adjustment can be obtained.

Further, in another preferable aspect of the invention, at least one of the optical elements disposed closer to the angle widening reflection section is preferably movable. Thus, the focus adjustment can be performed with the simple configuration which can easily be designed.

Further, in another preferable aspect of the invention, the image forming section includes a plurality of mirrors, and at least one of the mirrors is preferably movable. Thus, the configuration capable of performing the focus adjustment can be obtained.

Further, in another preferable aspect of the invention, the image forming section preferably includes a spatial light modulation device for modulating the light from the light source in accordance with the image signal. In the case in which the light from the light source section is modulated by the spatial light modulation device, the light source section needs only to emit a predetermined amount of light, and do not need to adjust the amount of light in accordance with the image signal. Thus, an image can easily be displayed on the irradiated surface.

Further, in another preferable aspect of the invention, the light source section preferably emits a laser beam, and the image forming section preferably includes a scanning section for scanning the laser beam from the light source, thereby displaying an image on the irradiated surface. In the case in which an image is displayed on the irradiated surface by scanning the laser beam from the light source section by the scanning section, although the light source section needs to be adjusted in accordance with the image signal, the image can be displayed without using the projection lens. Thus, an image can easily be displayed on the irradiated surface.

### BRIEF DESCRIPTION OF THE DRAWINGS

The invention will now be described with reference to the accompanying drawings, wherein like numbers refer to like elements.

FIG. 1 is a diagram showing a schematic configuration of a projector according to a first embodiment of the invention.

FIG. 2 is a diagram showing a schematic configuration of an optical engine.

FIG. 3 is a diagram schematically showing an optical system of a projection engine section.

FIG. 4 is a diagram showing a simulation of the behavior of the light modulated in accordance with an image signal.

FIG. 5 is a diagram showing a simulation of the behavior of the light modulated in accordance with an image signal.

FIG. 6 is a diagram for explaining an adjustment of the size of an image by a projector.

FIG. 7 is a diagram for explaining a relationship between the distance from a projection position and the size of an image.

FIG. 8 is a diagram for explaining a focus adjustment.

FIG. 9 is a diagram for explaining a focus adjustment.

FIG. 10 is a diagram showing a schematic configuration of a projection engine section according to a second embodiment of the invention.

### DESCRIPTION OF EXEMPLARY EMBODIMENTS

Hereinafter, embodiments of the invention will be described in detail with reference to the accompanying drawings.

### First Embodiment

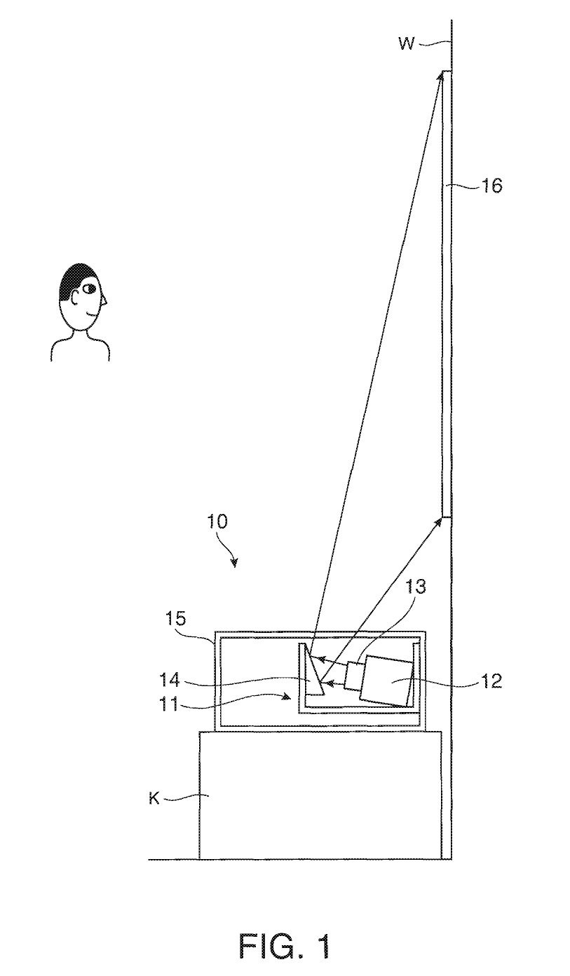

FIG. 1 shows a schematic configuration of a projector 10 according to a first embodiment of the invention. The projector 10 is a front projection projector for projecting light corresponding to an image signal. The projector 10 performs close-up projection from a position close to an irradiated surface, for example, a position about several tens of centimeters distant from a wall surface W on which a screen 16 is disposed. The projector 10 is provided with a projection engine section 11. The projection engine section 11 projects the light modulated in accordance with the image signal to the screen 16 as the irradiated surface. The project ion engine section 11, is provided with an optical engine 12, a projection lens 13, and an aspherical mirror 14. The optical engine 12, the projection lens 13, and the aspherical mirror 14 are housed in the projection engine section 11, and are configured to be moved integrally by moving the projection engine section 11.

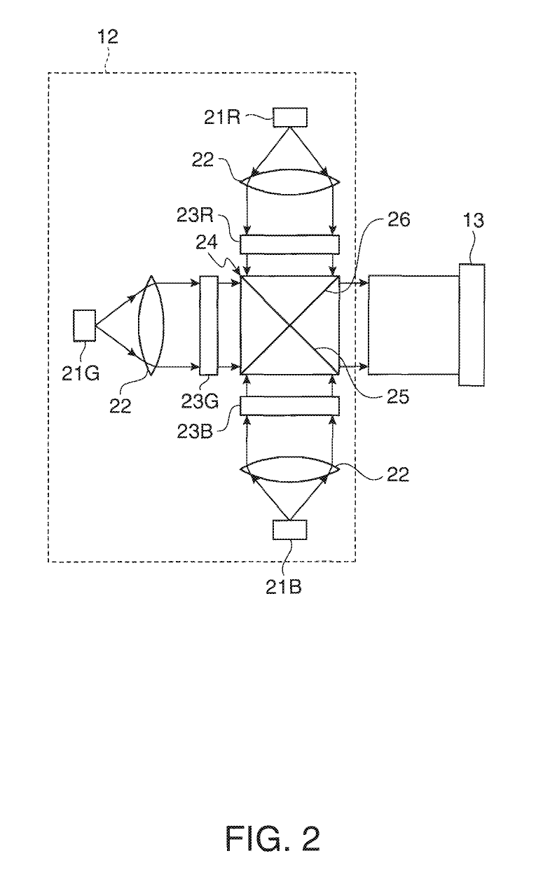

FIG. 2 shows a schematic configuration of the optical engine 12. A red (R.) LED 21R as a solid-state light source is a light source section for supplying R light. The R light from the red (R) LED 21R enters an R light spatial light modulation device 23R after being collimated by a collimator lens 22. The R light spatial light modulation device 23R is a spatial light modulation device for modulating the R light in accordance with the image signal, and is a transmissive liquid crystal display device. The R light modulated by the B light spatial light modulation device 23R enters a cross dichroic prism 24 as a color composition optical system.

A green (G) LED 21G as a solid-state light source is a light source section for supplying G light. The G light from the green (G) LED 21G enters a G light spatial light modulation device 23G after being collimated by a collimator lens 22. The G light spatial light modulation device 23G is a spatial light modulation device for modulating the G light in accordance with the image signal, and is a transmissive liquid crystal display device. The G light modulated by the G light spatial light modulation device 23G enters the cross dichroic prism 24 from a different side from the R light.

A blue (B) LED 21B as a solid state light source is a light source section for supplying B light. The B light from the blue (B) LIED 21B enters a B light spatial light modulation device 23B after being collimated by a collimator lens 22. The B light spatial light modulation device 23B is a spatial light modulation device for modulating the B light in accordance with the image signal, and is a transmissive liquid crystal display device. The B light modulated by the B light spatial light modulation device 23B enters the cross dichroic prism 24 from a different side from the R light and the G light. It should be noted that the optical engine 12 can also have a configuration using a homogenizing optical system for homogenizing the intensity distribution of a light beam, such as a rod integrator, a fly-eye lens, or an overlapping lens.

The cross dichroic prism 24 has a pair of first and second dichroic films 25, 26 disposed substantially perpendicular to each other. The first dichroic film 25 reflects the R light and transmits the G light and the B light. The second dichroic film 26 reflects the B light and transmits the R light and the G light. The cross dichroic prism 24 combines the R, G, and B light entering from the sides different from each other to emit the combined light in the direction towards the projection lens 13. The projection lens 13 projects the light combined by the cross dichroic prism 24.

As the transmissive liquid crystal display device, for example, a high temperature polysilicon TFT liquid crystal panel (HTPS) can be used. The optical engine 12 is not limited to the case in which the transmissive liquid crystal display device is used as the spatial light modulation device. As the spatial light modulation device, a reflective liquid crystal display device (Liquid Crystal On Silicon: LCOS), a digital micromirror device (DMD), a grating light valve (GLV), and so on can also be used. The projector 10 is not limited to have a configuration provided with the spatial light modulation device for every colored light beam. The projector 10 can be arranged to have a configuration of modulating two or three colored light beams by a single spatial light modulation device. Further the optical engine 12 is not limited to the case in which the LED is used as the light source section. As the light source section, for example, other solid-state light sources than the LED such as a laser source, or a lamp such as a super high-pressure mercury lamp can also be used.

Going back to FIG. 1, the aspherical mirror 14 is disposed at a position opposed to the projection lens 13. The aspherical mirror 14 is an angle widening reflection section for making the light from the projection lens 13 wide-angle by reflection, and has a curved surface having an aspheric shape. The aspherical mirror 14 has a function of making the light from the projection lens 13 wide-angle, and a function of folding the light from the project ion lens 13 to proceed in the direction towards the screen 16. The R light spatial light modulation device 23R, the G light spatial light modulation device 23G, the B light spatial light modulation device 23B, the projection lens 13, and the aspherical mirror 14 form an image forming section for projecting to display an image having a desired size on the screen 16 as the irradiated surface using the light beams from the red (R) LED 21R, the green (G) LED 21G, and the blue (B) LED 21B as a light source section. The aspherical mirror 14 can be composed by forming a reflective film on a substrate including, for example, a resin member. As the reflective film, a layer of a highly reflective member, a layer of a metal member such as aluminum, a dielectric multi-layer film, and so on can be used. Further, it is also possible to form a protective film including a transparent member on the reflective film.

The aspherical mirror 14 provided with a curved shape can fold the light and make the light wide-angle simultaneously. By making the light wide-angle not only by the projection lens 13 but also by the aspherical mirror 14, the projection lens 13 can be decreased in size compared to the case in which the light is made wide-angle only by the projection lens 13. The projection lens 13 and the aspherical mirror 14 enlarge the image and form the image on the screen 16. The projection lens 13 carries out the function of enlarging the image and forming the image on the screen 16. The aspherical mirror 14 carries out the function of enlarging the image. The aspherical mirror 14 can appropriately be changed in shape so as to correct the distortion of the image.

A housing 15 houses the projection engine section 11. The housing 15 is formed to have an inside dimension with which the projection engine section 11 is movable inside the housing 15. The screen 16 is a reflective screen for reflecting the light from the projection engine section 11. The screen 16 is arranged to be able to diffuse the light in a desired range where an observer exists, thus a preferable viewing angle characteristic can be provided.

The projection engine section 11 can completely be housed inside the housing 151 or alternatively, can be arranged to protrude from the housing 15 in a part of the projection engine section 11, for example, a part of the aspherical mirror 14. It is also possible to provide a mirror for folding the light path between the projection lens 13 and the aspherical mirror 14. In the case in which the configuration of folding the light path by about 90 degrees by the mirror is adopted, the optical engine 12 is disposed so as to emit light in the vertical direction of the sheet of FIG. 1 or the depth direction of the sheet thereof. Thus, the whole of the projection engine section 11 can be disposed at a position closer to the wall surface W.

The projector 10 is placed on a rack K disposed close to the wall surface W. Besides the above configuration, the projector 10 can be placed on, for example, the floor, a desk, or a sideboard. Since the projector 10 has a compact configuration, the installation place therefor can easily be assured. By arranging the projector 10 to be able to be placed adjacent to the wall surface W, a large screen can be displayed even in a small room.

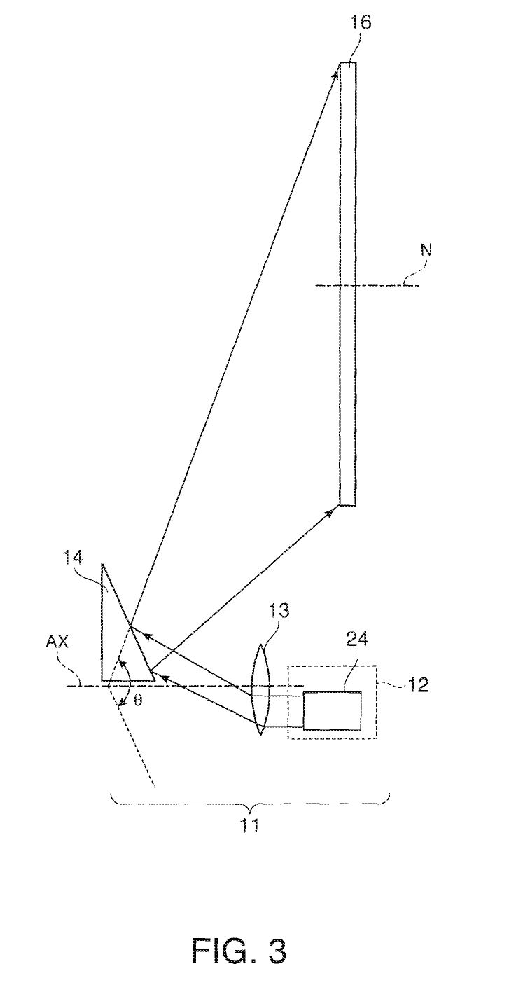

FIG. 3 is a diagram schematically showing the optical system of the projection engine section 11. The projection lens 13 and the aspherical mirror 14 are disposed so as to have the optical axes substantially identical to each other. The normal line N of the screen 16 is substantially parallel to the optional axis of the projection lens 13 and the optical axis of the aspherical mirror 14. The projection lens 13 and the aspherical mirror 14 form a so-called coaxial optical system in which both of them have a common optical axis AX. Furthers the projection engine section 11 and the screen 16 form a so-called shift optical system for making the light modulated in accordance with the image signal proceed while shifted to a specific side from the optical axis AX.

Specifically, it makes the light modulated in accordance with the image signal proceed while being shifted towards the upper side of the sheet of FIG. 3 from the optical axis AX. On the other hand, a central normal line of the field formed as a virtual field on the exit surface of the cross dichroic prism 24 in the optical engine 12 is parallel, to the optical axis AX, and is shifted to the opposite side to the specific side, namely towards the lower side of the sheet of FIG. 3 from the optical axis AX. According to such a configuration, the projection engine section 11 inputs the light with a large incident angle to the screen 16. The incident angle is defined as an angle formed between the normal line N of the screen 16 and the incident light beam.

By adopting the coaxial optical system, a normal design approach for the coaxial system can be adopted. Therefore, it becomes possible to reduce the design manpower and to realize an optical system with reduced aberration. The aspherical mirror 14 can be formed to have a shape of substantially rotational symmetry about the optical axis AX, for example, a shape obtained by cutting out a part excluding the apex section from a cone. By forming the aspherical mirror 14 to have the shape roughly rotationally symmetrical about the optical axis AX the optical axis of the aspherical mirror 14 and the optical axes of other components can easily be made identical. Since the aspherical mirror 14 has an axisymmetric aspheric shape, it can be processed by a simple method such as shaping on a lathe. Therefore, the aspherical mirror 14 can easily be manufactured with a high accuracy.

The projector 10 provided with the projection lens 13 and the aspherical mirror 14 adopts a super wide-angle optical system with a field angle θ of at least no less than 150 degrees, for example 160 degrees. Further, by adopting the shift optical system which uses only a part of the angle range of the wide-angle tight, the traveling directions of the light beams can be uniformed. In the case of the present embodiment, for example, the minimum incident angle in the screen 16 is 70 degrees and the maximum incident angle therein is 80 degrees. By adopting the shift optical system, the difference in the incident angle among the incident light beams to the screen 16 can be controlled to be no greater than about 10 degrees.

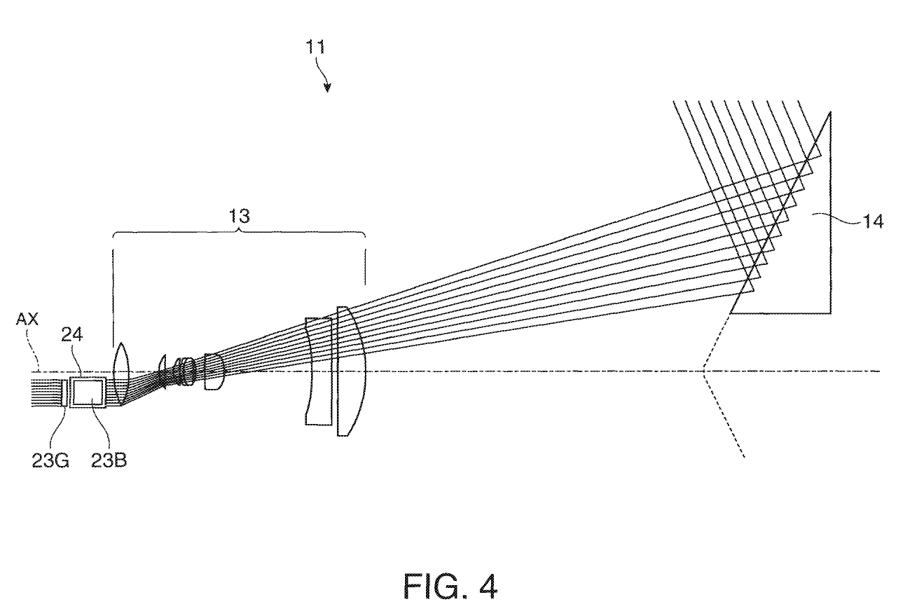

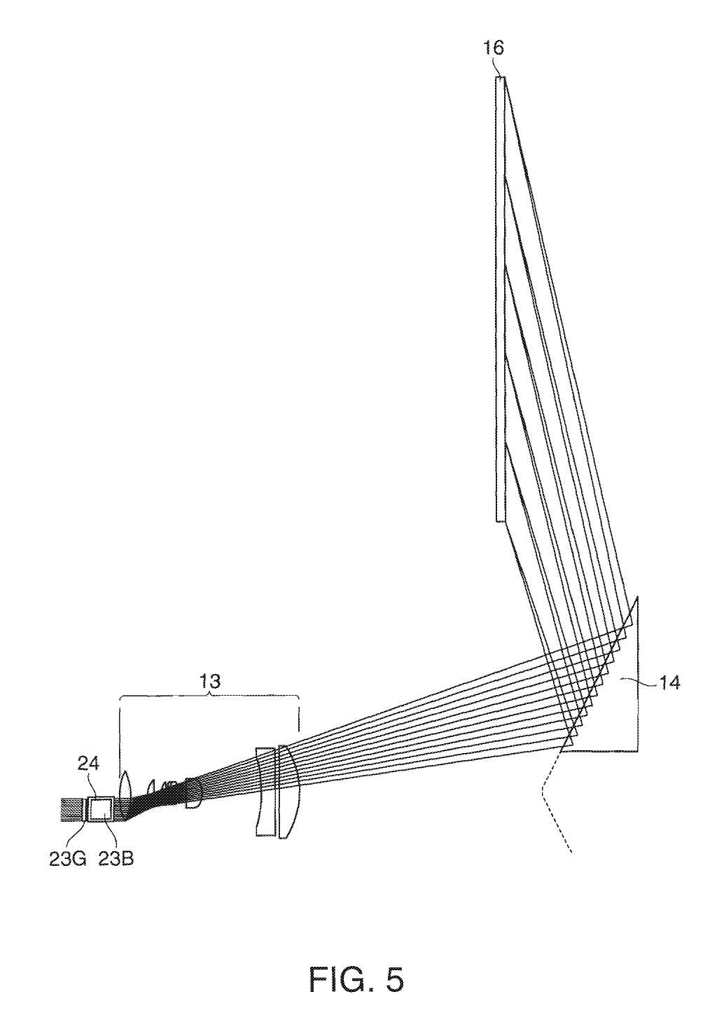

FIGS. 4 and 5 are diagrams showing a simulation of the behavior of the light modulated in accordance with an image signal. As shown in FIG. 4, the projection lens 13 is composed of nine spherical lenses. The spherical lens is an optical element for transmitting and deflecting the light. By shifting the G light spatial light modulation device 23G, the B light spatial light modulation device 23B, and the R light spatial light modulation device 23R not shown (and disposed behind the cross dichroic prism 24) perpendicularly from the optical axis AXs the shift optical system is realized. As shown in FIG. 5, the projection lens 13 forms an image on the screen 16 with the light transmitted through the aspherical mirror 14. It should be noted that the configuration of the projection lens 13 is not limited to what is explained in the present embodiment, but any configurations can be adopted providing the wide-angle light can be obtained by the configurations.

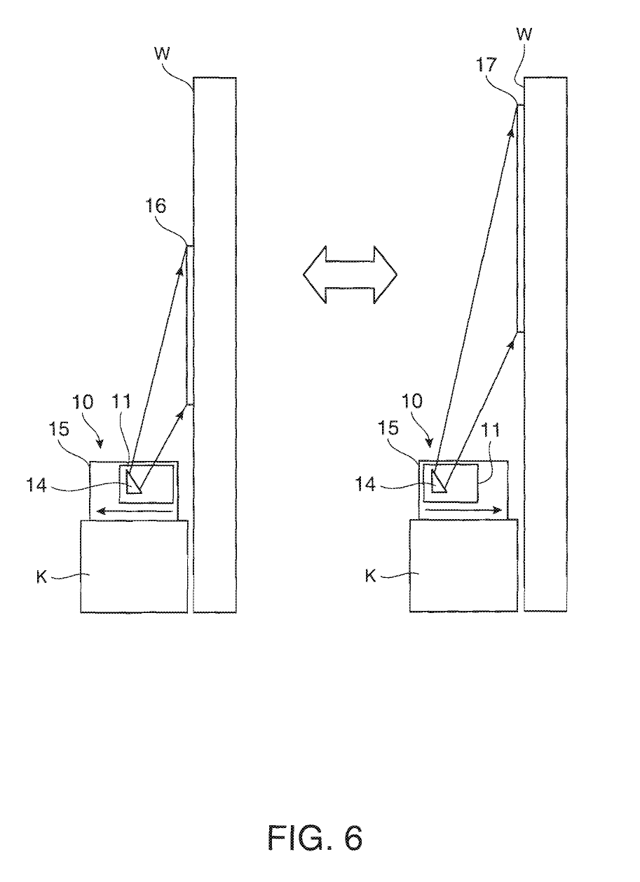

FIG. 6 is a diagram for explaining the adjustment of the screen size by the projector 10. The projection engine section 11 is configured to be able to move inside the housing 15 in a direction substantially perpendicular to the screens 16, 17 as the irradiated surfaces. The direction substantially perpendicular to the screens 16, 17 denotes the direction substantially parallel to the optical axis and along the light path. In the state shown on the left of the outline arrow in the drawing, the protector 10 displays a screen having a diagonal size of, for example, 45 inches on the screen 16. In this case, the projection engine section 11 is placed at a position on the side of the wall surface W and inside the housing 15. When, the projection engine section 11 is moved in the direction indicated by the arrow receding from the wall surface W in the housing 15 from the state displaying the 45-inch screen, the state show on the right side of the outline arrow in the drawings.

In, the state shown on the right of the outline arrow in the drawing, the projector 10 displays a screen having a diagonal size of, for example, 67 inches on the screen 17. In this case, the projection engine section 11 is placed at a position on the opposite side of the wall surface W and inside the housing 15. The screen 17 for displaying 67-inch screen is larger than the screen 16 for displaying the 45-inch screen and disposed vertically upper side of the screen 16. By moving the projection engine section 11 in a direction indicated by the arrow coming closer to the wall surface W inside the housing 15 from the state displaying the 67-inch screen, the projector 10 returns to the state displaying the 45-inch screen. As described above, the projector 10 can adjust the screen size into a small screen of 45 inches and a large screen of 67 inches by moving the projection engine section 11 inside the housing 15. The projector 10 according to the embodiment of the invention can perform adjustment of the screen size without moving the body of the projector 10.

The projection engine section 11 can be moved, for example, automatically in accordance with the input operation instructing the adjustment of the screen size, or manually. Since the projection engine section 11 is only required to be reciprocated in a direction along the light path, it is possible to have a configuration of moving, for example, on a linear rail or along a linear guide. Further, although in the present embodiment, the case in which the screens 16, 17 different in size are prepared respectively for displaying the small screen and the large screen is explained, it is also possible to display either of the small and large screens with the same screen.

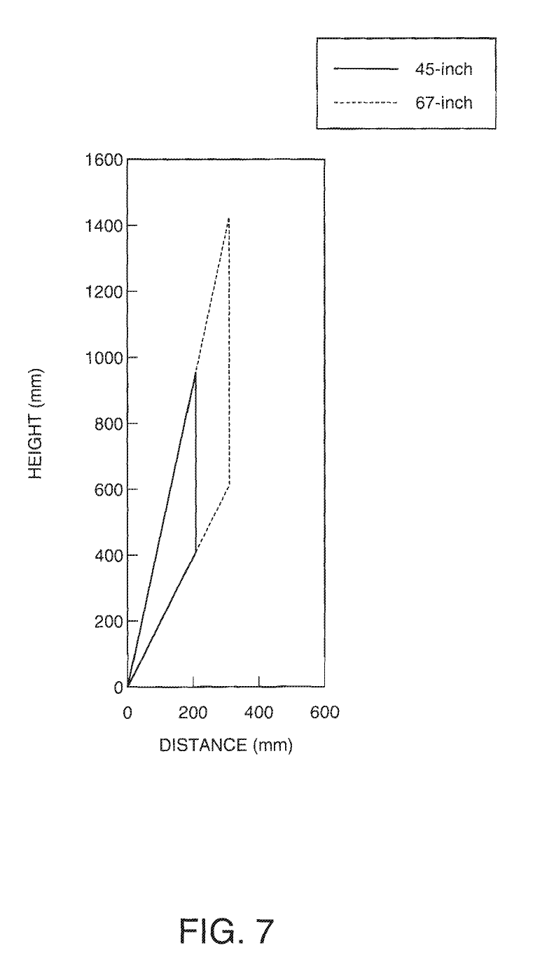

FIG. 7 is a diagram for explaining the relationship between the distance from the projection position from which the light is projected by the projector 10 and the screen size. The vertical axis of the graph represents a height from the projection position to the display position, and the horizontal axis thereof represents a distance from the projection position to the display position. The distance from the projection position to the display position denotes the distance along the direction substantially perpendicular to the irradiated surface. The variation in the distance from the projection position and the display position between the case with the 45-inch screen illustrated with a solid line and the case with the 67-inch screen illustrated with a broken line stays within about 100 mm. Providing the housing 15 has a size normally used therefor, the movement of about 100 mm is sufficiently allowed for the projection engine section 11. By using the ultra short focus optical system, the screen size can dramatically be changed by such a movement of the projection engine section 11 as allowed with the normal sized housing 15.

In the present embodiment, the maximum incident angle of the light beam in the screens 16, 17 is, for example, 80 degrees. The distance from the wall surface W to the projection position depends on the incident angle (tan θ) of the light beam. Therefore, if the maximum incident angle is changed from 80 degrees to 70 degrees, the necessary movement amount of the projection engine section 11 between the 45-inch and 67-inch screens becomes about twice. In consideration of the inside dimension of the normal housing 15, it is very difficult to double the movement amount of the projection engine section 11, for example, from about 100 mm to about 200 mm. Therefore, it is preferable for the projector 10 to nave the maximum incident angle of the light beam in the screens 16, 17 as large as possible, for example, 80 degrees or larger.

Regarding the optical system of the projection engine section 11, by eliminating the need for incorporating the zoom function into the design of the optical system, the zoom function can easily be realizes without increasing difficulty in designing the optical system and complexity of the configuration of the optical system. Since it is only required to make the projection engine section 11 movable, a configuration which can easily be designed can be adopted, thus reduction in the manufacturing cost becomes possible. Further, a highly reliable zoom mechanism with a high accuracy can be realized with a simple configuration. Thus, an advantage that the screen size can easily be adjusted in the case of performing close-up projection can be obtained. The configuration of the projector 10 is not limited to what enables the projection engine section 11 to move in a direction substantially perpendicular to the irradiated surface. It is sufficient for the projection engine section 11 to be able to move in a direction along the light path. For example, in the case in which a configuration of folding the light path by about 90 degrees by the mirror disposed between the projection lens 13 and the aspherical mirror 14 is adopted, the projection engine section 11 can be arranged to be able to move in a direction substantially parallel, to the irradiated surface, the direction substantially parallel to the light path.

With the projector 10, it becomes possible to enjoy appreciation corresponding to the content, for example, ordinary television programs can be appreciated with a small screen, and a content requiring the sense of presence such as a movie can be appreciated with a large screen. It should be noted that the projector 10 is not limited to what adjusts the screen size between the 45-inch and 67-inch screens. Available image sizes can preferably be set in accordance with the configuration of the projector 10. Further, besides the configuration capable of switching between two kinds of screens different in size from each other, the configuration capable of switching among three or more kinds of screens different in size among each other can be adopted.

The projector 10 is arranged to be capable of performing close-up projection, thus the restriction in the installation position can be eased, and the space reduction also becomes possible. Further, display with a large screen becomes possible even in a small room, and in addition, the consideration to preventing intervenient into the light path can also be reduced. In the trend of the larger screen not only of business-use video equipment but also of home-use video equipment, the projectors capable of displaying a large screen have been attracting attention. If the projector is required to be placed at a position rather distant from the screen, the projector should be placed at the center of a room if the room is not so large. It is difficult to permanently fix at the center of a room at home. Further, the installation operation of the projector becomes indispensable every time the projector is used, and in addition, connection to external equipment such as a DVD device must be performed.

According to the projector 10 of the embodiment of the invention, the body of the projector 10 can permanently be fixed at a position close to the wall, thus the bother of installation and connection can be reduced. Further, in contrast to the fact that the projectors are often placed at positions close to the observers in the related art, the projector 10 of the embodiment of the invention can be placed at a position close to the wall surface W and distant from the observer. By placing the projector 10 at a position distant from the observer, the influence caused by the heat from the lamp as a heat source, the rotation noise of the radiation fan, and so on to the observer can be reduced, thus comfortable appreciation of pictures becomes possible.

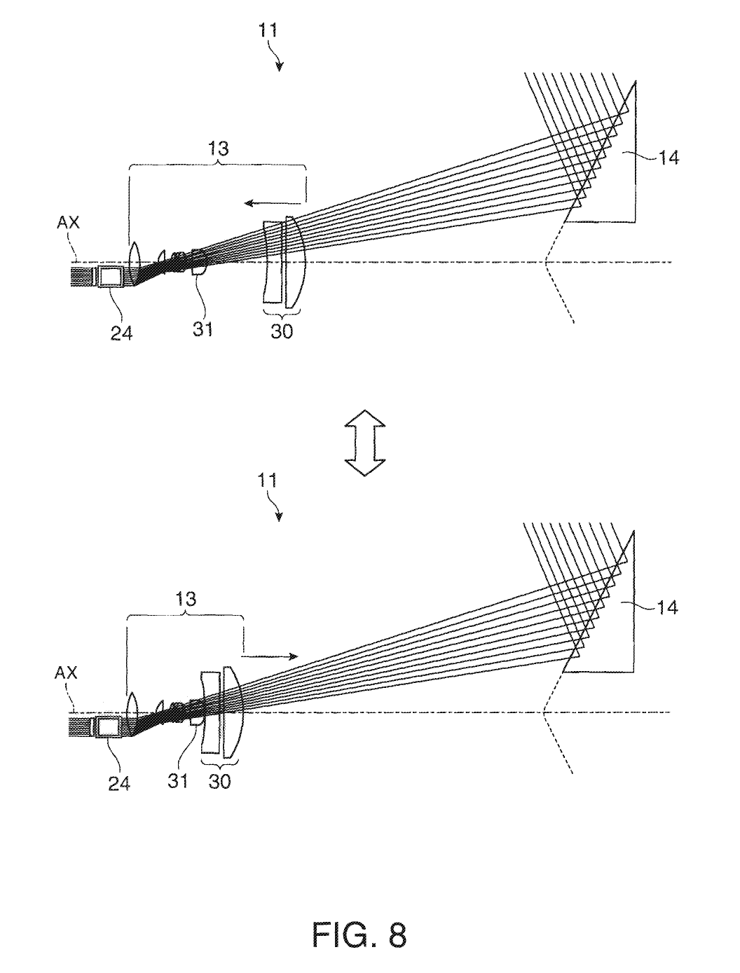

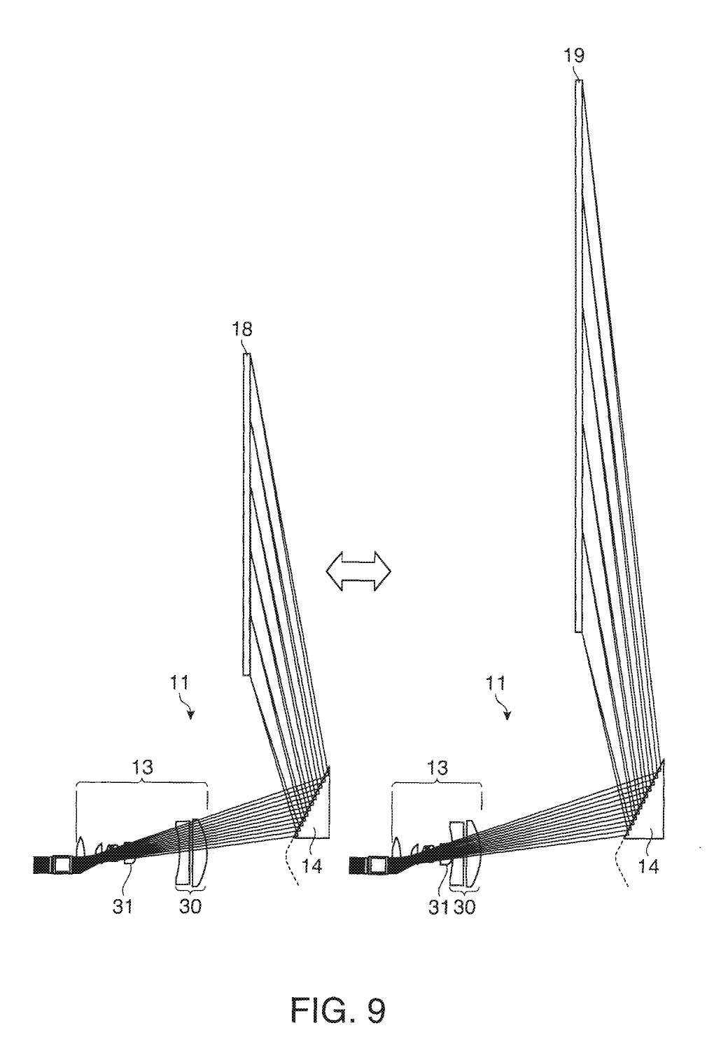

FIGS. 8 and 9 are diagrams for explaining the focus adjustment. In the projector 10, since the projection distance is varied in the process of adjusting the screen size, the focus adjustment becomes necessary. The projection engine section 11 is preferably configured to be able to move in a direction along the light path, and at the same time, to allow the focus adjustment. The two lenses 30 out of the projection lens 13, disposed closer to the aspherical mirror 14, are provided movable in the direction of the optical axis AX. The focus adjustment in the projection engine section 11 is performed by moving the two lenses 30. The lenses 30 are each a spherical lens, the optical element for transmitting and deflecting the light. Regarding the other lenses out of the projection lens 13 than the two lenses 30, the relative positional relationships with the aspherical mirror 14 are arranged to be always constant.

For example, in the case of displaying a 57-inch screen, as shown on the upper side of the outline arrow in FIG. 8, the two lenses 30 are disposed at the position closer to the aspherical mirror 14 in the projection lens 13. By disposing the two lenses 30 at this position, as exemplified on the left side of the outline arrow in FIG. 9, an image is formed on the screen 18 for displaying the 57-inch screen. In this way, the focus adjustment in the 57-inch screen can be achieved.

Then, it is assumed that the screen size is adjusted to be a 91-inch screen. On this occasion, the two lenses 30 are moved in the direction indicated by the arrow receding form the aspherical mirror 14. Further, as shown on the lower side of the outline arrow in FIG. 8, the two lenses 30 are moved to the position closer to the other lens 31 out of the projection lens 13 and adjacent to the two lenses 30. By moving the two lenses 30 to this position, as exemplified on the right side of the outline arrow in FIG. 9, an image is formed on the screen 19 for displaying the 91-inch screen. In this way, the focus adjustment in the 91-inch screen can be achieved. In the case of adjusting the screen size to 57 inches again, the focus adjustment can be achieved by shifting the two lenses in the direction indicated by the arrow coming closer to the aspherical mirror 14.

By performing the focus adjustment while adjusting the screen size, a high quality image can be displayed every time the screen size is adjusted. The two lenses 30 can be moved, for example, automatically in accordance with the input operation instructing the focus adjustment, or manually. Further, it is also possible to automatically perform the focus adjustment simultaneously with the adjustment of the screen size by arranging that the two lenses 30 can be moved in conjunction with the movement of the projection engine section 11 for the screen size adjustment.

The configuration of the projection engine section 11 is not limited to what performs the focus adjustment by moving the two lenses 30 out of the projection lens 13, disposed closer to the aspherical mirror 14. Any configurations for moving at least one lens as an optical element out of the projection lens 13, disposed closer to the aspherical mirror 14, can be adopted. By adopting the configuration for moving the lens out of the projection lens 13, disposed closer to the aspherical mirror 14, the focus adjustment can be performed with a simple configuration which can easily be designed. Further, it is enough that at least one lens out of the lenses forming the projection lens 13 can be moved. For example, the configuration for moving another lens than the lens disposed closest to the aspherical mirror 14 is also acceptable.

The configuration of the projector 10 is not limited to what projects the light from the lower side of the irradiated surface. The projector 10 can also have a configuration of projecting the light from the upper side of the irradiated surface. In the case of projecting the light from the upper side of the irradiated surface, the projector 10 is disposed turning the state shown in FIG. 1 upside down. In the case of protecting the light from the upper side of the irradiated surface, the projector 10 can be installed, for example, to be suspended from the ceiling surface in the room. According to the projector 10 of the embodiment of the invention, since relocation can be eliminated (after the projector 10 has once been installed, it becomes possible to permanently fix the projector 10 to the ceiling while achieving the zoom function. It is enough for the projector 10 to have a configuration provided with at least the zoom unction, the focus adjustment function can be eliminated.

### Second Embodiment

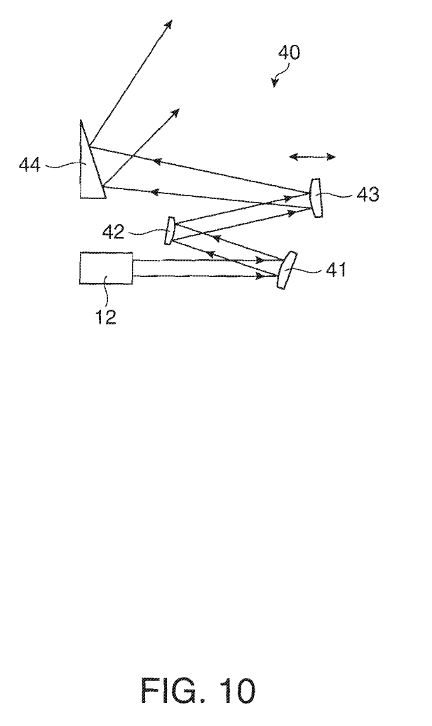

FIG. 10 shows a schematic configuration of a projection engine section 40 according to a second embodiment of the invention. The projection engine section 40 can be applied to the projector 10 (see FIG. 1) described above. The projection engine section 40 of the present embodiment is characterized in including four aspherical mirrors 41, 42, 43, and 44. The same parts as in the first embodiment are denoted with the same reference numerals, and the duplicated explanations will be omitted. The aspherical mirrors 41, 42, 43, and 44 are each a mirror having a curved surface of an aspheric shape. The projection engine section 40 forms a so-called eccentric optical system which has no common optical axis.

The light from the projection engine section 40 enters the screen not shown after being reflected by each of the aspherical mirrors 41, 42, 43, and 44. The fourth aspherical mirror 44 for reflecting the light passing through the three aspherical mirrors 41, 42, and 43 is the angle widening reflection section having the greatest contribution to making the light wide-angle of all the aspherical mirrors 41, 42, 43, and 44, and has the same function as the aspherical mirror 14 (see FIG. 3) in the first embodiment.

Similarly to the projection engine section 11 (see FIG. 1) of the first embodiment described above, the projection engine section 40 moves in a direction along the light path, thereby performing an adjustment of the screen size. Further, the projection engine section 40 moves the aspherical mirror 43 for reflecting the light at a position anterior to the fourth aspherical mirror 44 back and forth as indicated by the two-headed arrow shown in the drawing, thereby performing the focus adjustment. Thus, also in the case of the present embodiment, a high quality image can be displayed evenly time the screen size is adjusted.

It is enough for the projection engine section 40 to have a configuration of performing the focus adjustment by moving at least one of the four aspherical mirrors 41, 42, 43, and 44. Further, the configuration of the projection engine section 40 is not limited to what has four aspherical mirrors 41, 42, 43, and 44, but is only required to include a plurality of mirrors. In this case, the projection engine section 40 can have the configuration capable of performing the focus adjustment by arranging at least one of the mirrors to be movable.

The projector 10 can be arranged to be a laser scan projector provided with a scanning section such as a galvanometer mirror as the image forming section as a substitute for the image forming section in the embodiments described above to scan the laser beam from the light source, thereby projecting an image on the projection surface. The projector can be a so-called rear projector, which supplies one of the surfaces of the screen with light and allows the viewer to appreciate an image by viewing the light emitted from the other surface of the screen.

As described hereinabove, the projector according to the embodiments of the invention is suitable for the case of performing the close-up projection.

The entire disclosure of Japanese Patent Application Nos:2006-319740, filed Nov. 28, 2006, and 2007-246672, filed Sep. 25, 2007 are expressly incorporated by reference herein.

What is claimed is:

1. A projector comprising:
a projection engine section including a light source section and an image forming section for projecting an image on an irradiated surface using light from the light source section; and
a housing for housing the projection engine section,
wherein the projection engine section is capable of moving in the housing in a direction along a light path.

2. The projector according to claim 1,
wherein the image forming section includes an angle widening reflection section for making light wide-angle by reflection.

3. The projector according to claim 2,
wherein the image forming section includes a projection lens, and
the angle widening reflection section makes the light from the projection lens wide-angle.

4. The projector according to claim 3,
wherein the projection lens and the angle widening reflection section are disposed so as to have substantially identical optical axes, and shift the light to a specific side from the optical axes.

5. The projector according to claim 1,
wherein the projection engine section is configured so as to allow a focus adjustment.

6. The projector according to claim 5,
wherein the image forming section includes a projection lens having a plurality of optical elements, and an angle widening reflection section for making the light from the projection lens wide-angle, and
at least one of the optical elements forming the projection lens is movable in an optical axis direction.

7. The projector according to claim 6,
wherein at least one of the optical elements disposed closer to the angle widening reflection section is movable.

8. The projector according to claim 5,
wherein the image forming section includes a plurality of mirrors, and at least one of the mirrors is movable.

9. The projector according to claim 3,
wherein the image forming section includes a spatial light modulation device for modulating the light from the light source in accordance with the image signal.

10. The projector according to claim 1,
wherein the light source section emits a laser beam, and
the image forming section includes a scanning section for scanning the laser beam from the light source, thereby displaying an image on the irradiated surface.
